(19) United States
(12) Patent Application Publication
(10) Pub. No.: US 2024/0426326 A1
(43) Pub. Date: Dec. 26, 2024

(54) Dual-Parallel Actuator Piston Interface

(71) Applicant: Woodward, Inc., Fort Collins, CO (US)

(72) Inventors: Jorge A. Pinedo, Fort Collins, CO (US); Justin E. Hans, Fort Collins, CO (US); Kevin M. Orloske, Fort Collins, CO (US)

(21) Appl. No.: 18/214,133

(22) Filed: Jun. 26, 2023

(51) Int. Cl. F15B 15/14

(52) U.S. Cl. CPC F15B 15/1447; F15B 15/1433; F15B 15/1404; F15B 18/00

(57) ABSTRACT

The subject matter of this specification can be embodied in, among other things, an apparatus that includes a first assembly having a first piston rod having a first rod end, a second assembly arranged substantially parallel to the first piston assembly and having a second piston rod having a second rod end, an end assembly defining a first aperture configured to receive the first rod end, and a second aperture configured to receive the second rod end, a first retaining cap configured to affix to the first rod end, abut the end assembly when affixed to the first rod end, and retain the first rod end within the first aperture, and a second retaining cap configured to affix to the second rod end, abut the end assembly when affixed to the second rod end, and retain the second rod end within the second aperture.

### TECHNICAL FIELD

This instant specification relates to fluid actuators, more specifically dual-parallel fluid actuators.

### BACKGROUND

Fly-by-wire actuation systems are becoming more common in the aircraft industry and require position-sensing capability. Some packaging arrangements use linear variable displacement transformers (LVDT) as position sensors, and the LVDTs are arranged within a hollow piston body. Adjustment and/or calibration of an installed LVDT require an ability to access the LVDT from the exposed end of the piston in order to allow an operator to access and adjust the installed LVDT after assembly. However, the features to enable access to the LVDT can weaken the piston end joint, compromising the joint's ability to withstand severe bending moments that may be developed in dual-parallel piston architectures.

### SUMMARY

In general, this document describes a dual-parallel fluid actuator apparatus.

In a general example, an actuator apparatus includes a first piston assembly having a first piston rod having a first piston rod end, a second piston assembly arranged substantially parallel to the first piston assembly and having a second piston rod having a second piston rod end, an end assembly defining a first aperture configured to receive the first piston rod end, and a second aperture configured to receive the second piston rod end, a first retaining cap assembly configured to affix to the first piston rod end, abut the end assembly when affixed to the first piston rod end, and retain the first piston rod end within the first aperture, and a second retaining cap assembly configured to affix to the second piston rod end, abut the end assembly when affixed to the second piston rod end, and retain the second piston rod end within the second aperture.

Various embodiments can include some, all, or none of the following features. The end assembly can include a first shoulder extending radially partly inward from a first inner surface of the end assembly and partly defining the first aperture and partly defining a third aperture arranged coaxially within the first aperture, where the first piston rod end can be arranged to partly extend through the third aperture. The actuator apparatus can include a collar extending radially away from an outer surface of the first piston rod proximal the first piston rod end, and the end assembly includes an end face configured to coaxially contact the collar. The actuator apparatus can include a circumferential recess defined in the outer surface, and the collar can include a retaining clip partly arranged within the circumferential recess. The first piston rod end can include a first thread defined upon a first outer surface of the first piston rod, and the first retaining cap assembly can include a second thread defined upon a first inner surface of the first retaining cap, where the first thread can be configured to threadedly engage with the second thread. The actuator apparatus can include a longitudinal piston rod recess defined in an outer surface of the first piston rod, a longitudinal end assembly recess defined in the first aperture, and an anti-rotation key arranged at least partly within the longitudinal piston rod recess and at least partly within the longitudinal end assembly recess. The first retaining cap assembly can define an opening therethrough, and can include a removable plug arranged to occlude the opening. The first piston rod defines a first longitudinal cavity having a first opening at the first piston rod end, the second piston rod can define a second longitudinal cavity having a second opening at the second piston rod end, or both. The end assembly can include a mounting assembly or a clevis assembly.

In another general example, a method of assembling an actuator includes inserting a first piston rod end of a first piston assembly into a first aperture defined in an end assembly, removably affixing a first retaining cap assembly to the first piston rod end, and removably retaining, by the affixing, the first piston assembly to the end assembly.

Various implementations can include some, all, or none of the following features. The method can include inserting a second piston rod end of a second piston assembly into a second aperture defined in the end assembly, wherein the second piston assembly can be arranged substantially parallel to the first piston assembly, removably affixing a second retaining cap assembly to the second piston rod end, and removably retaining, by the affixing, the second piston assembly to the end assembly. Inserting the first piston rod end of the first piston assembly into the first aperture defined in the end assembly can include inserting the first piston rod end of the first piston assembly through a second aperture arranged coaxially within the first aperture, where the end assembly can include a shoulder extending radially partly inward from an inner surface of the end assembly and partly defining the first aperture and partly defining the second aperture. The method can include contacting an end face of the end assembly with a collar extending radially away from an outer surface of the first piston assembly proximal the first piston rod end. The collar can include a retaining clip, and the method can include arranging the retaining clip at least partly within a recess defined in the outer surface. Removably affixing the first retaining cap assembly to the first piston rod end can include threading the first retaining cap assembly onto the first piston rod end, where the first piston rod end can include a first thread defined upon a first outer surface of the first piston assembly, and the first retaining cap assembly can include a second thread defined upon a first inner surface of the first retaining cap, where the first thread can be configured to threadedly engage with the second thread. The method can include inserting an anti-rotation key into a cavity partly defined by a longitudinal piston rod recess defined in an outer surface of the first piston assembly and a longitudinal end assembly recess defined in the first aperture. The method can include removably affixing a plug to the first retaining cap assembly to occlude an opening defined though the first retaining cap assembly. The method can include accessing a first longitudinal cavity defined in the first piston assembly and having a first opening at the first piston rod end.

In another general example, an actuator apparatus includes a piston assembly having a piston rod having a piston rod end, an end assembly defining an aperture configured to receive the piston rod end, and a retaining cap assembly configured to affix to the piston rod end, abut the end assembly when affixed to the piston rod end, and retain the piston rod end within the aperture.

Various embodiments can include some, all, or none of the following features. The end assembly can include one or more of a shoulder extending radially partly inward from an inner surface of the end assembly and partly defining the aperture and partly defining a second aperture arranged coaxially within the aperture, where the piston rod end can be arranged to partly extend through the second aperture, a collar extending radially away from an outer surface of the piston rod proximal the piston rod end, and the end assembly can include an end face configured to coaxially contact the collar, and a first longitudinal cavity defined by the piston rod and having a first opening at the piston rod end.

The systems and techniques described here may provide one or more of the following advantages. First, a system can provide a high level of fatigue strength under the action of piston bending moments. Second, the system allows access to internal cavities for position sensor adjustment.

The details of one or more implementations are set forth in the accompanying drawings and the description below. Other features and advantages will be apparent from the description and drawings, and from the claims.

### DESCRIPTION OF DRAWINGS

FIG. 1 is a perspective view of an example dual-parallel fluid actuator piston interface apparatus.

FIG. 2 is a side view of the example dual-parallel fluid actuator piston interface apparatus of FIG. 1.

FIG. 3 is a top view of the example dual-parallel fluid actuator piston interface apparatus of FIGS. 1-2.

FIG. 4 is a sectional top view of the example dual-parallel fluid actuator piston interface apparatus of FIGS. 1-3.

FIG. 5 is an exploded perspective view of the example dual-parallel fluid actuator piston interface apparatus of FIGS. 1-4.

FIG. 6 is flow chart that shows an example of a process for assembling an example dual-parallel fluid actuator piston interface apparatus.

### DETAILED DESCRIPTION

This document describes a dual-parallel fluid actuator piston interface apparatus. The apparatus includes a structure and arrangement of features that can provide access to a cavity within each piston (e.g., to access a linear variable displacement transformer, or LVDT, arranged within the cavity) without substantially compromising the ability of the apparatus to withstand severe bending moments that can be caused by asynchronous movements of dual-parallel pistons. In general, the piston rods are removably coupled to a rod end by trapping a portion of the rod end between the piston rod and a threaded retaining cap that is threaded onto a matingly threaded end of the piston rod.

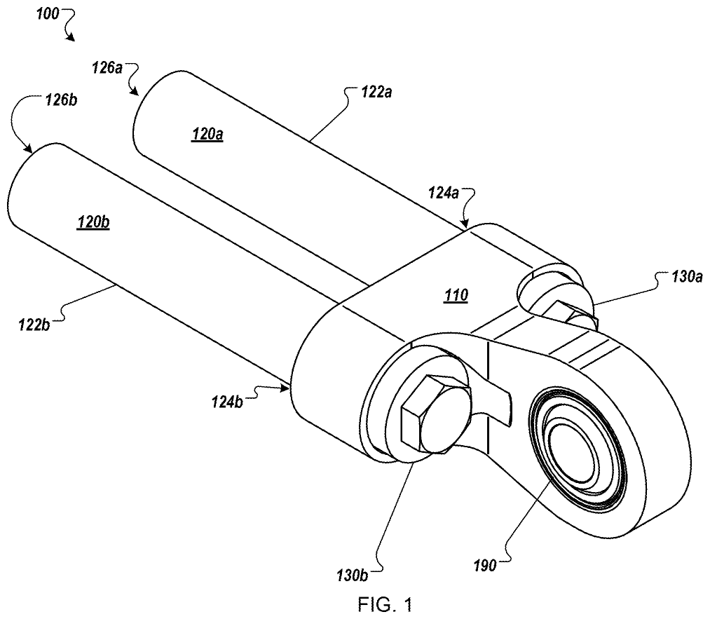

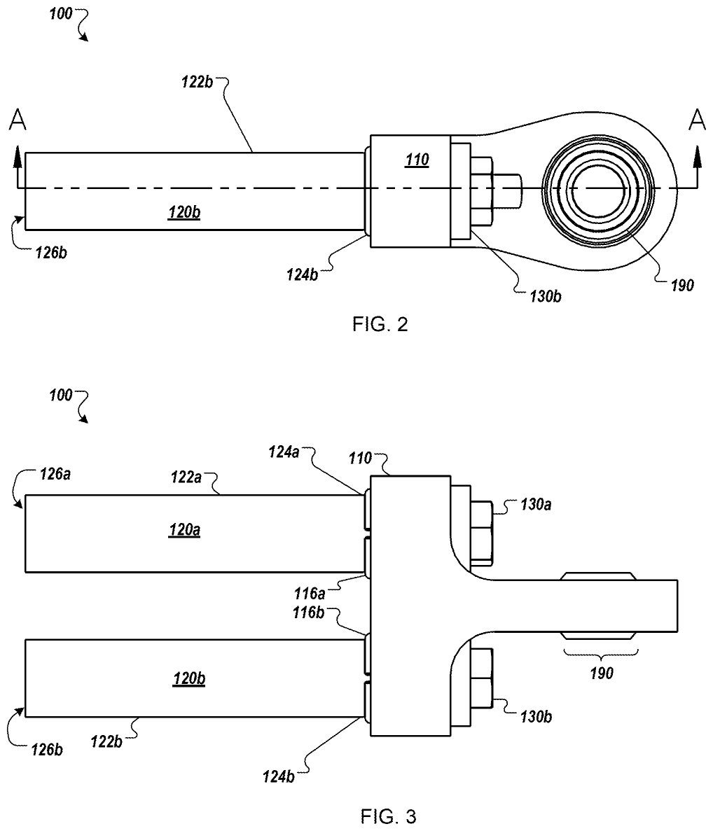

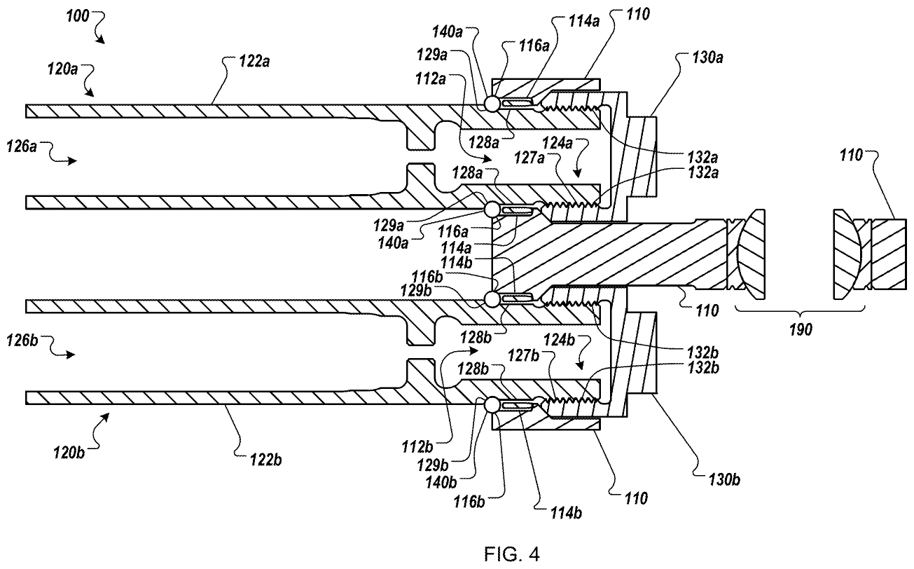

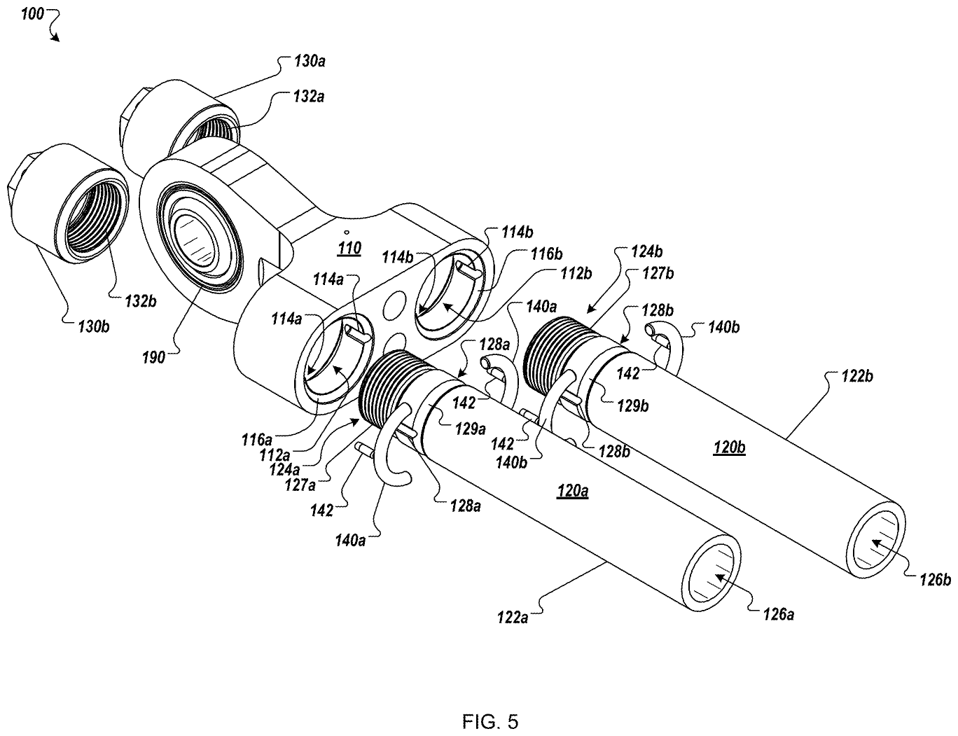

FIGS. 1-4 show various views an example dual-parallel fluid actuator piston interface apparatus 100. FIG. 1 is a perspective view of the example dual-parallel fluid actuator piston interface apparatus 100. FIG. 2 is a side view of the example dual-parallel fluid actuator piston interface apparatus 100. FIG. 3 is a top view of the example dual-parallel fluid actuator piston interface apparatus 100. FIG. 4 is a sectional top view of the example dual-parallel fluid actuator piston interface apparatus 100 taken along section A-A of FIG. 2. FIG. 5 is an exploded perspective view of the example dual-parallel fluid actuator piston interface apparatus 100.

The apparatus 100 includes a rod end assembly 110, a piston assembly 120a, a piston assembly 120b, a retaining cap 130a, and a retaining cap 130b. The piston assembly 120a has a piston rod 122a that has a piston rod end 124a and defines a cavity 126a. The piston assembly 120b has a piston rod 122b that has a piston rod end 124b and defines a cavity 126b. The rod end assembly includes a mounting interface assembly 190 (e.g., a clevis assembly, bearing assembly) configured to be removably affixed to an external assembly.

The rod end assembly 110 defines an aperture 112a configured to receive the piston rod end 124a, and defines an aperture 112b configured to receive the piston rod end 124b. The rod end assembly 110 also defines a collection of recesses 114a that further define the aperture 112a, and a collection of recesses 114b that further define the aperture 112b.

An outer periphery of the piston rod end 124a includes a thread 127a defined upon the outer surface of the piston rod end 124a, and an outer periphery of the piston rod end 124b includes a thread 127b defined upon the outer surface of the piston rod end 124b. The piston rod end 124a also defines a collection of recesses 128a and 129a, and the piston rod end 124b also defines a collection of recesses 128b and 129b. The recesses 128a and 128b are semi-cylindrical (e.g., defining a half-cylinder shape) and aligned longitudinally relative to their respective piston rods 122a and 122b. The recesses 129a and 129b are semi-toroidal, circumferential recesses (e.g., defining a half-toroid shape) that circumscribe their respective piston rod ends 124a and 124b. A retaining clip 140a (shown as a split retaining ring in FIG. 5 for illustration purposes) is arranged within the recess 129a, coaxially about the outer periphery of the piston rod end 124a, and a retaining clip 140b (e.g., a toroidal ring, shown as a split ring in FIG. 5 for illustration purposes) is arranged within the recess 129b, coaxially about the outer periphery of the piston rod end 124b. The retaining clips 140a-140b are configured as collars that extend radially away from the outer surfaces of the piston rods 122a-122b proximal the piston rod ends 124a-124b.

During assembly of the piston assembly 120a to the rod end assembly 110, the piston rod end 124a is inserted into the aperture 112a to bring the retaining clip 140a into contact with a peripheral shoulder recess 116a defined at an end of the aperture 112a. The peripheral shoulder recess 116a is defined by the rod end assembly 110 as a semi-toroidal, concave recess configured to compliment the retaining clip 140a. The piston assembly 120a is rotated so the recesses 128a align with the recesses 114a to form a collection of cylindrically shaped, longitudinal recesses between the piston rod end 124a and the rod end assembly 110. A collection of anti-rotation keys 142 (e.g., pins) can be inserted into the aligned recesses 128a and 114a to prevent rotation of the piston assembly 120a relative to the rod end assembly 110.

During assembly of the piston assembly 120b to the rod end assembly 110, the piston rod end 124b is inserted into the aperture 112b to bring the retaining clip 140b into contact with a peripheral shoulder recess 116b defined at an end of the aperture 112b. The peripheral shoulder recess 116b is defined by the rod end assembly 110 as a semi-toroidal, concave recess configured to compliment the retaining clip 140b. The piston assembly 120b is rotated so the recesses 128b align with the recesses 114b to form a collection of cylindrically shaped, longitudinal recesses between the piston rod end 124b and the rod end assembly 110. Additional ones of the collection of anti-rotation keys 142 can be inserted into the aligned recesses 128b and 114b to prevent rotation of the piston assembly 120b relative to the rod end assembly 110.

The retaining cap 130a has a thread 132a defined upon its inner peripheral surface. The thread 132a is formed to be complimentary to the thread 127a. The retaining cap 130b has a thread 132b defined upon its inner peripheral surface. The thread 132b is formed to be complimentary to the thread 127b. During assembly, the retaining cap 130a is threaded onto the piston rod end 124a within the aperture 112a, drawing the piston rod end 124a into the aperture 112a, and securely seating the retaining clip 140a between the recess 129a and the recess 116a and occluding the cavity 126a. During assembly, the retaining cap 130b is threaded onto the piston rod end 124b within the aperture 112b, drawing the piston rod end 124b into the aperture 112b, and securely seating the retaining clip 140b between the recess 129b and the recess 116b and occluding the cavity 126b.

In some embodiments, a linear variable transformer (LVDT) (not shown) can be arranged in one or each of the cavity 126a and/or the cavity 126b. Adjustment and calibration of the LVDTs can be done by removing the retaining caps 130a-130b to access the space and the LVDTs within the cavities 126a-126b.

In some embodiments, LVDT calibration can be affected by the relative position of the piston rod ends 124a-124b to the rod end assembly 110. For example, the piston rod end 124a may need to be fully seated during calibration of the LVDT. In some embodiments, assembly of the piston rod ends 124a-124b to the rod end assembly 110 can include the use of temporary caps in place of the retaining caps 130a-130b during initial assembly of the apparatus 100 and/or adjustment of LVDTs. The temporary caps can be threaded like the retaining caps 130a-130b but can be formed as open-ended cylinders that can retain the piston housing ends 124a-124b within the apertures 112a-112b while also providing access to the cavities 126a-126b. Once calibration/adjustment of the LVDTs is complete, the temporary caps can be removed and replaced with the retaining caps 130a-130b.

In some embodiments, the retaining caps 130a-130b can be formed as two-piece assemblies having an open-ended cylindrical section having the threads 132a-132b and a removable plug configured to be removably affixed to the cylindrical section to occlude one of the open ends. Assembly of the piston rod ends 124a-124b to the rod end assembly 110 can include the use of the cylindrical sections during initial assembly of the apparatus 100 and/or adjustment of LVDTs. Once calibration/adjustment of the LVDTs is complete, the plugs can be removably affixed to the cylindrical sections in order to occlude the cavities 126a-126b.

In operation, the piston assemblies 120a and/or 120b can experience stresses that can urge misalignment between the piston rod assemblies 120a-120b and the rod end assembly 110. For example, an asynchronicity between extension/retraction of the piston rod assemblies 120a-120b can create a torque at the piston rod ends 124a-124b between the piston rod assemblies 120a-120b and the rod end assembly 110. The example apparatus 100 accommodates such stresses by transferring non-axial forces from the piston rod 122a-122b, through the retaining clips 116a-116b, to the rod end assembly 110. As a result, minimal bending stresses are present at the threads 127a and 127b of the piston.

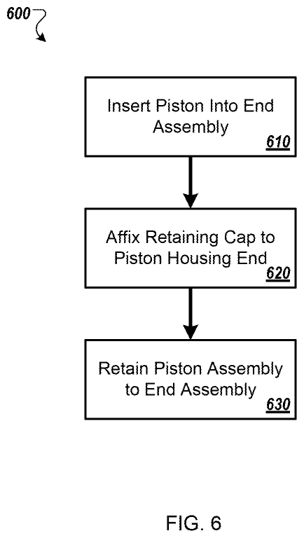

FIG. 6 is flow chart that shows an example of a process 600 for assembling an example dual-parallel fluid actuator apparatus. The processes may be performed, for example, to assemble an apparatus such as the example dual-parallel fluid actuator apparatus 100 of FIGS. 1-5. For clarity of presentation, the description that follows uses the dual-parallel fluid actuator apparatus as an example for describing the process 600. However, another apparatus, system, or combination of systems, may be used to perform the processes 600.

At 610, a first piston rod end of a first piston assembly is inserted into a first aperture defined in a rod end assembly. For example, the piston housing end 124a can be inserted into the aperture 112a.

In some implementations, inserting the first piston rod end of the first piston assembly into the first aperture defined in the end assembly can include inserting the first piston rod end of the first piston assembly through a second aperture arranged coaxially within the first aperture, where the end assembly includes a shoulder extending radially partly inward from an inner surface of the end assembly and partly defining the first aperture and partly defining the second aperture.

At 620, a first retaining cap assembly is removably affixed to the first piston rod end. In some implementations, removably affixing the first retaining cap assembly to the first piston rod end can include threading the first retaining cap assembly onto the first piston rod end, wherein the first piston rod end includes a first thread defined upon a first outer surface of the first piston assembly, and the first retaining cap assembly includes a second thread defined upon a first inner surface of the first retaining cap, where the first thread is configured to threadedly engage with the second thread. For example, the retaining cap 130a can be threaded onto the piston rod end 124a.

At 630, the first piston assembly is removably retained to the rod end assembly based on the affixing. For example, a portion of the rod end assembly 110 can be captured between the retaining cap 130a and the piston rod 122a.

In some implementations, the process 600 can include inserting a second piston rod end of a second piston assembly into a second aperture defined in the rod end assembly, wherein the second piston assembly is arranged substantially parallel to the first piston assembly, removably affixing a second retaining cap assembly to the second piston rod end, and removably retaining, by the affixing, the second piston assembly to the rod end assembly. For example, the piston rod end 124b can be inserted into the aperture 112b, the retaining cap 130b can be threaded onto the piston rod end 124b, and a portion of the rod end assembly 110 can be captured between the retaining cap 130b and the piston rod 122b.

In some implementations, the process 600 can include contacting an end face of the rod end assembly with a collar extending radially away from an outer surface of the first piston assembly proximal the first piston rod end. In some implementations, the collar can be a retaining clip, and the process 600 can include arranging the retaining clip at least partly within a recess defined in the outer surface. For example, the retaining clip 140a can be arranged within the peripheral shoulder recess 116a and become contactingly captured between the peripheral shoulder recess 116a and the end of the aperture 112a.

In some implementations, the process 600 can include inserting an anti-rotation key into a cavity partly defined by a longitudinal piston rod recess defined in an outer surface of the first piston assembly and a longitudinal end assembly recess defined in the first aperture. For example, the piston assembly 120a can be rotated so the recesses 128a align with the recesses 114a to form a collection of cylindrically-shaped, longitudinal recesses between the piston rod end 124a and the rod end assembly 110, and the collection of anti-rotation keys 142 can be inserted into the aligned recesses 128a and 114a to prevent rotation of the piston assembly 120a relative to the rod end assembly 110.

In some implementations, the process 600 can include removably affixing a plug to the first retaining cap assembly to occlude an opening defined though the first retaining cap assembly. For example, the retaining cap 130a can be formed as two-piece assemblies having an open-ended cylindrical section having the thread 132a and a removable plug configured to be removably affixed to the cylindrical sections in order to occlude the cavity 126.

In some implementations, the process 600 can include accessing a first longitudinal cavity defined in the first piston assembly and having a first opening at the first piston rod end. For example, an LVDT arranged within the cavity 126a can be accessed through the aperture 112a and the piston rod end 124a.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. An actuator apparatus comprising:
a first piston assembly comprising a first piston rod defining a first longitudinal cavity having a first opening at a first piston rod end and a second opening at a second piston rod end longitudinally opposite the first piston rod end;
a second piston assembly arranged substantially parallel to the first piston assembly and comprising a second piston rod having a second third piston rod end;
an end assembly defining a first aperture configured to receive the first piston rod end, and a second aperture configured to receive the second piston rod end;
a first retaining cap assembly configured to affix to the first piston rod end, abut the end assembly when affixed to the first piston rod end, and retain the first piston rod end within the first aperture; and
a second retaining cap assembly configured to affix to the second piston rod end, abut the end assembly when affixed to the second piston rod end, and retain the second piston rod end within the second aperture.

2. The actuator apparatus of claim 1, wherein the end assembly comprises:
a first shoulder extending radially partly inward from a first inner surface of the end assembly and partly defining an end of the first aperture and arranged coaxially within the first aperture.

3. The actuator apparatus of claim 1, further comprising a collar extending radially away from an outer surface of the first piston rod proximal the first piston rod end, and the end assembly comprises an end face configured to coaxially contact the collar.

4. The actuator apparatus of claim 3, further comprising a circumferential recess defined in the outer surface, and the collar comprises a retaining clip partly arranged within the circumferential recess.

5. The actuator apparatus of claim 1, wherein:
the first piston rod end comprises a first thread defined upon a first outer surface of the first piston rod; and
the first retaining cap assembly comprises a second thread defined upon a first inner surface of the first retaining cap assembly, wherein the first thread is configured to threadedly engage with the second thread.

6. The actuator apparatus of claim 1, further comprising:
a longitudinal piston rod recess defined in an outer surface of the first piston rod;
a longitudinal end assembly recess defined in the first aperture; and
an anti-rotation key arranged at least partly within the longitudinal piston rod recess and at least partly within the longitudinal end assembly recess.

7. The actuator apparatus of claim 1, wherein the first retaining cap assembly defines an opening therethrough, and further comprises a removable plug arranged to occlude the opening.

8. The actuator apparatus of claim 1, wherein
the second piston rod defines a second longitudinal cavity having a third opening at the third piston rod end and a fourth opening at a fourth piston rod end longitudinally opposite the third piston rod end.

9. The actuator apparatus of claim 1, wherein the end assembly further comprises a mounting assembly or a clevis assembly.

10-18. (canceled)

19. An actuator apparatus comprising:
a piston assembly comprising a piston rod defining a first longitudinal cavity having a first opening at a piston rod end and a second opening at a second piston rod end longitudinally opposite the piston rod end;
an end assembly defining an aperture configured to receive the piston rod end; and
a retaining cap assembly configured to affix to the piston rod end, abut the end assembly when affixed to the piston rod end, and retain the piston rod end within the aperture.

20. The actuator apparatus of claim 19, further comprising one or more of:
a shoulder extending radially partly inward from an inner surface of the end assembly and partly defining the aperture and partly defining a second aperture arranged coaxially within the aperture, wherein the piston rod end is arranged to partly extend through the second aperture; and
a collar extending radially away from an outer surface of the piston rod proximal the piston rod end, and the end assembly comprises an end face configured to coaxially contact the collar.

21. The actuator apparatus of claim 19, wherein the retaining cap assembly encloses the first opening.

22. The actuator apparatus of claim 1, wherein the first retaining cap assembly encloses the first opening.

23. An actuator apparatus comprising:
a first piston assembly comprising a first piston rod having a first piston rod end;
a second piston assembly arranged substantially parallel to the first piston assembly and comprising a second piston rod having a second piston rod end;
an end assembly defining a first aperture configured to receive the first piston rod end, and a second aperture configured to receive the second piston rod end;
a first retaining cap assembly configured to affix to the first piston rod end, abut the end assembly when affixed to the first piston rod end, and retain the first piston rod end within the first aperture;
a second retaining cap assembly configured to affix to the second piston rod end, abut the end assembly when affixed to the second piston rod end, and retain the second piston rod end within the second aperture
a longitudinal piston rod recess defined in an outer surface of the first piston rod;
a longitudinal end assembly recess defined in the first aperture; and
an anti-rotation key arranged at least partly within the longitudinal piston rod recess and at least partly within the longitudinal end assembly recess.
